(19) United States
(12) Patent Application Publication
(10) Pub. No.: US 2025/0353471 A1
(43) Pub. Date: Nov. 20, 2025

(54) METHOD FOR CLEANING VEHICLE SENSORS

(71) Applicant: VALEO SYSTEMES D'ESSUYAGE, La Verriere (FR)

(72) Inventors: Denis THEBAULT, La Verriere (FR); Adrien PERET, La Verriere (FR); Maxime BAUDOUIN, La Verriere (FR); Giuseppe GRASSO, La Verriere (FR); Yoann DOLLE, La Verriere (FR)

(73) Assignee: VALEO SYSTEMES D'ESSUYAGE, La Verriere (FR)

(21) Appl. No.: 18/291,978

(22) PCT Filed: Jul. 11, 2022
(86) PCT No.: PCT/EP2022/069342

§ 371 Date: Feb. 18, 2025

(30) Foreign Application Priority Data
Jul. 28, 2021 (FR) FR2108204

(51) Int. Cl. B60S 1/56; B60S 1/48

(52) U.S. Cl. CPC B60S 1/56; B60S 1/481

(57) ABSTRACT

A method for cleaning a surface of a vehicle, comprising steps of: detecting whether the surface is dirty, triggering a cleaning counter if said surface is dirty, executing a primary cleaning phase employing at least one cleaning parameter, checking whether said surface is clean, resetting said cleaning counter and stopping execution of said primary cleaning phase if the surface is clean, otherwise incrementing said cleaning counter, and if it is lower than a primary threshold, reiterating said primary cleaning phase, if said cleaning counter is equal to said primary threshold, executing a secondary cleaning phase with said at least one cleaning parameter modified, and if said cleaning counter is equal to said secondary threshold, resetting it, stopping execution of said secondary cleaning phase, and executing a function ensuring safety of said vehicle.

### TECHNICAL FIELD

The present invention relates to a method for cleaning at least one sensor of a vehicle. It is particularly, but non-limitingly, applicable to motor vehicles.

### BACKGROUND OF THE INVENTION

In the field of motor vehicles, and in particular in autonomous or semi-autonomous motor vehicles, a plurality of sensors such as lidars, radars or even cameras are employed. These sensors in particular make it possible to perform a function whereby the environment of the vehicle is detected. For autonomous or semi-autonomous driving to be as efficient and as reliable as possible, the information provided by the sensors must be of the highest possible quality. Therefore, it is essential for the external surfaces of these sensors to be kept clean. Thus, said external surfaces need to be able to be frequently washed when they are dirty. To this end, there is a method for cleaning sensors of a vehicle known to those skilled in the art that detects that the surface to be cleaned is dirty, and then sprays a cleaning liquid at a defined flow rate for a defined length of time onto said surface in order to clean it.

One drawback of this prior art is that the dirt on the surface to be cleaned may be of various types. It may be dust, salt, mud, tar, insect remains, etc. However, since the cleaning process is uniform, it does not take into account the variability in the dirt, and often the surface is not cleaned effectively, even if it is cleaned a number of times in a row. As a result the detecting function of the sensor is degraded, this potentially endangering the occupants of the vehicle, in particular when the vehicle is an autonomous or semi-autonomous vehicle whose operation depends greatly on the detecting functions of its various sensors.

### SUMMARY OF THE INVENTION

In this context, the present invention aims to provide a method for cleaning at least one sensor of a vehicle that allows the aforementioned drawbacks to be solved.

To this end, the invention provides a method for cleaning at least one sensor of a vehicle, said at least one sensor comprising a surface to be cleaned, said cleaning method comprising steps of:
detecting whether said surface of said sensor is dirty,
triggering a cleaning counter if said surface is dirty,
activating a primary cleaning phase employing at least one cleaning parameter,
executing the primary cleaning phase,
checking whether said surface is clean,
if said surface is clean following said primary cleaning phase, resetting said cleaning counter and stopping execution of said primary cleaning phase,
otherwise incrementing said cleaning counter, and if said cleaning counter is lower than a primary threshold, reiterating said primary cleaning phase,
if said cleaning counter is equal to said primary threshold, stopping execution of said primary cleaning phase and activating a secondary cleaning phase with said at least one cleaning parameter modified,
executing said secondary cleaning phase,
checking whether said surface is clean,
if said surface is clean following said secondary cleaning phase, resetting said cleaning counter and stopping execution of said secondary cleaning phase,
otherwise incrementing said cleaning counter and if said cleaning counter is lower than a secondary threshold, reiterating said secondary cleaning phase, and if said cleaning counter is equal to said secondary threshold, resetting said cleaning counter, stopping execution of said secondary cleaning phase, and executing a function ensuring safety of said vehicle.

According to non-limiting embodiments, said cleaning method may further comprise one or more additional features, implemented alone or in any technically possible combination, from among the following.

According to one non-limiting embodiment, said at least one cleaning parameter is:
a flow rate of a primary cleaning fluid,
a pressure of a primary cleaning fluid,
a temperature of a primary cleaning fluid,
a composition of a primary cleaning fluid.

According to one non-limiting embodiment, said primary cleaning phase is carried out with a primary cleaning fluid and said secondary cleaning phase is carried out with a secondary cleaning fluid that is the same as the primary cleaning fluid or that is composed of said primary cleaning fluid and of an additional fluid.

According to one non-limiting embodiment, said primary cleaning phase is carried out with a primary cleaning fluid and said secondary cleaning phase is carried out with a secondary cleaning fluid different from the primary cleaning fluid.

According to one non-limiting embodiment, said primary threshold is equal to 3.

According to one non-limiting embodiment, said secondary threshold is equal to 5.

According to one non-limiting embodiment, said safety-ensuring function is:
a message sent to a human-machine interface of said vehicle to indicate the need for maintenance,
deactivation of the one or more functions of said vehicle that depend on detection by said sensor,
automatic navigation of said vehicle on a maintenance basis.

According to one non-limiting embodiment, said primary threshold and said secondary threshold are configured depending on the nature of said at least one sensor.

According to one non-limiting embodiment, said primary threshold and said secondary threshold are configured depending on ambient parameters.

According to one non-limiting embodiment, the cleaning method is applied to a plurality of sensors simultaneously.

According to one non-limiting embodiment, the detection comprises detecting the level of dirtiness of the surface.

According to one non-limiting embodiment, said at least one cleaning parameter is modified depending on said level of dirtiness.

According to one non-limiting embodiment, said at least one sensor is a lidar, a radar or a camera.

According to one non-limiting embodiment, the primary cleaning phase is a normal cleaning phase.

According to one non-limiting embodiment, the secondary cleaning phase is an intensive cleaning phase.

A system for cleaning at least one sensor of a vehicle is further provided, said at least one sensor comprising a surface to be cleaned, said cleaning system comprising:
(a) a detecting device configured to detect whether said surface of said at least one sensor is dirty or clean,
(b) an electronic control unit configured to:
activate a primary cleaning phase employing cleaning parameters,
if said surface is clean following said primary cleaning phase, resetting said cleaning counter, otherwise incrementing said cleaning counter,
if said cleaning counter is equal to said primary threshold, activating a secondary cleaning phase with said at least one cleaning parameter modified,
if said surface is clean following said secondary cleaning phase, resetting said cleaning counter, otherwise incrementing said cleaning counter,
if said cleaning counter is equal to said secondary threshold, resetting said cleaning counter and executing a function ensuring safety of said vehicle,
(c) a cleaning device configured to:
execute said primary cleaning phase, reiterate said primary cleaning phase if said surface is still not clean following the primary cleaning phase and if said cleaning counter is lower than the primary threshold,
stop execution of said primary cleaning phase if said surface is clean following the primary cleaning phase or if said cleaning counter is equal to said primary threshold,
execute said secondary cleaning phase,
reiterate said secondary cleaning phase if said surface is still not clean following the secondary cleaning phase and if said cleaning counter is lower than the secondary threshold, and
stop execution of said secondary cleaning phase if said surface is clean following the secondary cleaning phase or if said cleaning counter is equal to said secondary threshold.

Thus, by virtue of this cleaning method, cleaning of the surface of said at least one sensor is tailored thereto by means of cleaning parameters and of tests of the state of dirtiness of the surface of the sensor to be cleaned. In this way, the surface of the sensor is cleaned effectively. Counting the various cleaning phases allows cleaning to be stopped when it is not effective. Thus, this avoids wasting cleaning fluid by continuously cleaning a surface that cannot be cleaned even after a number of attempts.

### BRIEF DESCRIPTION OF DRAWINGS

The invention and the various applications thereof will be better understood on reading the following description and studying the accompanying figures, in which:

FIG. 1 is a flowchart of a method for cleaning at least one sensor of a vehicle, according to one non-limiting embodiment of the invention,

FIG. 2 is a schematic diagram of a system for cleaning at least one sensor of a vehicle configured to implement the cleaning method of FIG. 1, said cleaning system comprising a detecting device, an electronic control unit and a cleaning device, according to one non-limiting embodiment,

FIG. 3 illustrates the functions of the detecting device, of the electronic control unit and of the cleaning device of the cleaning system of FIG. 2, according to one non-limiting embodiment.

### DETAILED DESCRIPTION OF THE INVENTION

Elements that are identical in terms of structure or function and that appear in various figures are designated by the same references, unless indicated otherwise.

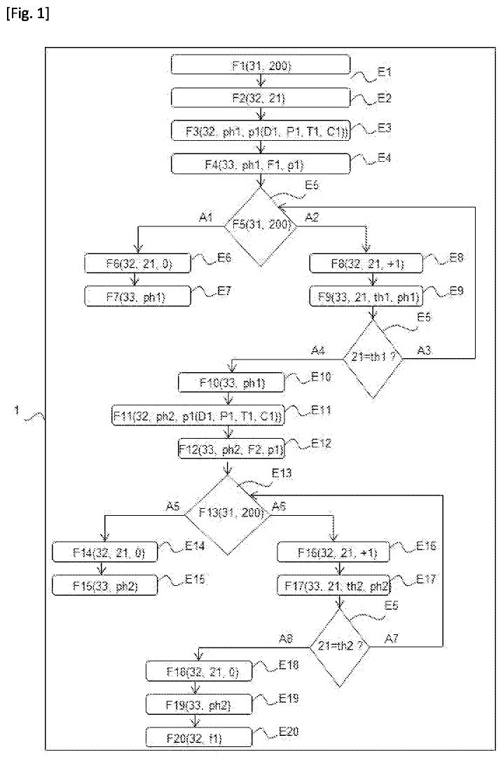

The method 1 for cleaning a sensor 20 of a vehicle 2 according to the invention is illustrated in FIG. 1. In one non-limiting embodiment, the vehicle 2 is a motor vehicle. By motor vehicle, what is meant is any type of motorized vehicle. This embodiment will be considered, by way of non-limiting example, in the remainder of the description. In the remainder of the description, the vehicle 2 is thus also referred to as the motor vehicle 2. In non-limiting embodiments, the motor vehicle 2 is an autonomous or semi-autonomous vehicle.

The motor vehicle 2 comprises at least one sensor 20. In non-limiting embodiments, the sensor 20 is a lidar, a radar or a camera. The sensor 20 comprises an external surface 200 to be cleaned, also called the surface 200. In the case of a radar, this external surface 200 is passed through by transmitted radar waves and returning radar waves received by the radar. In the case of a lidar, this external surface 200 is passed through by an emitted laser beam and returning waves received by the lidar. In the case of a camera, this external surface 200 is the external surface of the optics of the camera. The sensor 20 has a visibility threshold beyond which it can no longer operate correctly because its external surface 200 is too dirty.

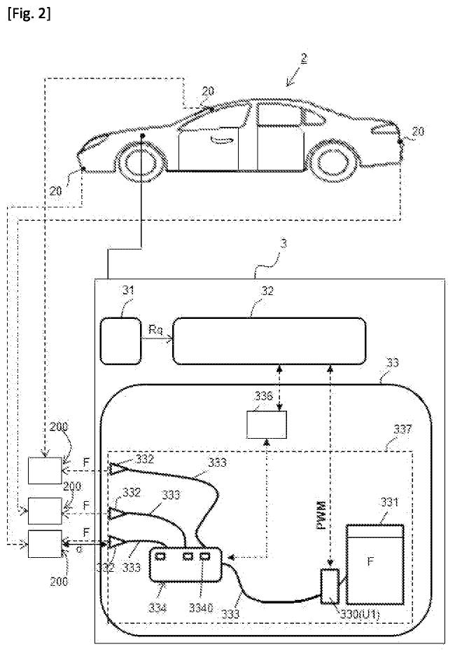

As illustrated in FIG. 2, in one non-limiting embodiment, the motor vehicle 2 comprises a plurality of sensors 20. This non-limiting embodiment will be considered, by way of non-limiting example, in the remainder of the description. In the context of an autonomous or semi-autonomous motor vehicle 2, there are dozens of sensors 20. In the non-limiting example of FIG. 2, for the sake of legibility of the figure, only three sensors have been shown, one on the front face of the motor vehicle 2, one at the top of the windscreen and one at the rear of the motor vehicle 2. It will be noted that of course sensors 20 may also be placed on the sides of the motor vehicle 2. The sensors 20 are configured to deliver information relating to the external environment of the motor vehicle 2, which information is used to perform functions for autonomous or semi-autonomous driving in particular. In non-limiting examples, this information is images of the external environment, or the presence of a stationary or moving object in front of, behind or to the side of the motor vehicle 2. The sensors 20 are therefore configured to perform a detecting function, which might be detection of a stationary or moving object or detection of the external environment such as a detection of markings on the ground.

Depending on the level of autonomy of the vehicle, in non-limiting examples the functions for autonomous or semi-autonomous driving comprise:
assistance with emergency braking,
automatic parking with steering management,
adaptive cruise control without driver intervention,
steering the vehicle (longitudinal and transverse path control, keeping the vehicle in its lane and adapting its speed to traffic flow),
managing the movement of the vehicle on motorways, on roads with visible markings,
steering the vehicle without driver intervention.

As illustrated in FIG. 2, the motor vehicle 2 comprises a cleaning system 3 comprising, in one non-limiting embodiment:
a detecting device 31 configured to detect whether the surface 200 to be cleaned of said sensor 20 is dirty,
an electronic control unit 32, and
a cleaning device 33.

In a first non-limiting embodiment, the detecting device 31 is the sensor 20 itself. The latter is configured to feed back information indicating that its visibility threshold has been reached, by means of a cleaning request Rq. In a second non-limiting embodiment, the detecting device 31 is said electronic control unit 32, which is configured to detect whether the surface 200 is dirty. Since various methods for detecting whether a surface 200 is dirty are known to those skilled in the art, they will not be described here. In FIG. 2, the detecting device 31 has been shown as being different from the electronic control unit 32 or from a sensor 20 because it may be either thereof.

As illustrated in FIG. 2, the cleaning device 33 comprises, in one non-limiting embodiment:
at least one pump 330 for cleaning sensors 20, which pump is configured to deliver a cleaning fluid F through ducts 333 to spray nozzles 332,
at least one storage tank 331 configured to store the cleaning fluid F,
a plurality of spray nozzles 332 configured to release the cleaning fluid F onto the external surfaces 200 of the sensors 20,
a plurality of ducts 333 configured to convey the cleaning fluid F from said at least one storage tank 331 to the spray nozzles 332,
a distributing module 334 comprising a plurality of solenoid valves 3340 configured to distribute the cleaning fluid F to the sensors 20 via the spray nozzles 332.

The electronic control unit 32 is configured to control said at least one cleaning pump 330 and said plurality of solenoid valves 3340.

In one non-limiting embodiment, the cleaning device 33 further comprises an electromagnet 336, also referred to as a solenoid, configured to open the plurality of solenoid valves 3340. In this case, the electronic control unit 32 controls this electromagnet 336.

In one non-limiting example, the cleaning fluid F is water. The cleaning pump 330, the storage tank 331, the plurality of ducts 333, and the distributing module 334 form a circuit 337 for distributing the cleaning fluid F. In one non-limiting embodiment (not shown), the motor vehicle 2 comprises two distributing circuits 337, one placed at the front and one placed at the rear of the motor vehicle 2. This allows the plurality of sensors 20, which are located at the front and rear of the motor vehicle 2 for example, to be washed simultaneously. Thus, in this non-limiting embodiment, the motor vehicle 2 comprises two storage tanks 331, one placed at the front and one placed at the rear, and two cleaning pumps 330, one placed at the front and one placed at the rear. Each cleaning pump 330 is placed directly at the outlet of one of the storage tanks 331. In FIG. 2, only one distributing circuit 337 has been illustrated. When the motor vehicle 2 comprises two distributing circuits 337, in this case, the electronic control unit 32 is configured to control the two cleaning pumps 330 and said plurality of solenoid valves 3340 of the two distributing circuits 337.

In one non-limiting embodiment, one spray nozzle 332 is associated with one sensor 20. There are thus as many spray nozzles 332 as there are sensors 20. A spray nozzle 332 is placed in proximity to the sensor 20 with which it is associated. Its distance d from the sensor 20 depends on the external surface 200 of the sensor 20 to be cleaned. The smaller the external surface 200, the closer the spray nozzle 332 is placed to the sensor 20. In one non-limiting embodiment, the distance d is comprised between 1 cm (centimeters) and 10 cm. In one non-limiting example, for a sensor 20 with a diameter of 15 mm (millimeters), such as a wide-angle camera, the distance d is 1 cm. In one non-limiting example, for a sensor 20 with dimensions of 20 cm-5 cm, such as a lidar, the distance d is 5 cm.

In one non-limiting embodiment, one spray nozzle 332 is associated with one solenoid valve 3340. Thus, the distributing module 334 comprises as many solenoid valves 3340 as spray nozzles 332, and hence delivery of the cleaning fluid F via a given spray nozzle 332 is governed by controlling only one solenoid valve 3340. The solenoid valves 3340 are controlled by the electronic control unit 32.

In one non-limiting embodiment, the cleaning pump 330 is an electronically controlled pump driven by an electric motor. In one non-limiting embodiment, the electric motor is a brushless motor. This guarantees the reliability of the cleaning pump 330 compared with a cleaning pump with a brushed electric motor. The cleaning pump 330 is powered by a supply voltage U1. The supply voltage U1 of the cleaning pump 330 may be modified on the basis of a PWM signal (PWM standing for pulse width modulation). This allows the speed of rotation of the electric motor to be modified. Modifying the speed of rotation modifies the pressure P1 of the cleaning fluid F output from the cleaning pump 330. In particular, increasing the speed of rotation leads to an increase in the pressure P1 of the cleaning fluid F. It is thus possible to configure the pressure P1 of the cleaning fluid F output from the cleaning pump 330 so that said pump delivers a defined pressure P1 with a view to pumping said cleaning fluid F into a spray nozzle 232 at a given flow rate D1.

As illustrated in FIG. 1, the cleaning method 1 comprises the following steps.

In an illustrated step E1, F1 (31, 200), the detecting device 31 detects whether the surface 200 of the sensor 20 is dirty. Detection is either performed by the sensor 20 itself, or directly by the electronic control unit 32. When detection is performed by the sensor 20 itself, the latter sends a cleaning request Rq to the electronic control unit 32. In one non-limiting embodiment, the electronic control unit 32 receives a plurality of cleaning requests Rq from N sensors 20, with N=1 to m, where m is an integer. In one non-limiting example considered in the remainder of the description, three sensors 20 are to be cleaned simultaneously. Thus, the electronic control unit 32 receives three cleaning requests Rq, one from each of the three sensors 20 to be cleaned.

In one non-limiting embodiment, this detecting step comprises detecting a level of dirtiness of the surface 200 to be cleaned. This will subsequently allow the one or more cleaning parameters p1 described below to be modified, depending on this level of dirtiness, and thus allow more targeted and therefore more effective cleaning.

In an illustrated step E2, F2 (32, 21, 0), the electronic control unit 32 triggers a cleaning counter 21 if the surface 200 is dirty. In one non-limiting example, this counter 21 is initially set to the value 0. By triggering, what is meant is that it activates it.

In an illustrated step E3, F3 (32, ph1, p1 (D1, P1, T1, C1)), the electronic control unit 32 activates a primary cleaning phase ph1 depending on at least one cleaning parameter p1. By activation, what is meant is that the electronic control unit 32 sends a command (not shown) to the cleaning device 33, said command comprising the cleaning parameters p1 so that the latter may execute the primary cleaning phase ph1 with said cleaning parameters p1. The primary cleaning phase Ph1 is a normal cleaning phase.

In non-limiting examples, said at least one cleaning parameter p1 is:
a flow rate D1 of a cleaning fluid F,
a pressure P1 of a cleaning fluid F,
a temperature T1 of a cleaning fluid F,
a composition C1 of a cleaning fluid F.

Thus, the cleaning parameters p1 have defined initial values. In non-limiting embodiments, the cleaning fluid F is water or a windshield-washing fluid.

In one non-limiting embodiment, activation sets a plurality of cleaning parameters p1.

In an illustrated step E4, F4 (33, ph1, F1, p1), the cleaning device 33 executes the primary cleaning phase ph1 with the one or more cleaning parameters p1. The primary cleaning phase ph1 is carried out with a primary cleaning fluid F1. Thus, the cleaning pump 330 is controlled to deliver an ordinary program.

The cleaning pump 20 is controlled by the electronic control unit 32 by means of a PWM signal (PWM standing for pulse width modulation), depending on sensor requirements, i.e. depending on the number N of sensors 20 to be cleaned simultaneously. The cleaning pump 330 ensures delivery of the primary cleaning fluid F1 through the ducts 333 to the spray nozzles 332 of the sensors 20 that must be cleaned.

When a solenoid 336 is used, the latter is controlled by the electronic control unit 32 to open the plurality of solenoid valves 3340 so that the primary cleaning fluid F1 is delivered to the spray nozzles 332 corresponding to the sensors 20 that must be cleaned.

In an illustrated step E5, F5 (31, 200), the detecting device 31 checks whether the surface 200 to be cleaned is clean.

If said surface 200 to be cleaned is clean following said primary cleaning phase ph1 (branch A1), in an illustrated step E6, F6 (32, 21, 0), said cleaning counter 21 is reset. It is reset by the electronic control unit 32. Next, in an illustrated step E7, F7 (33, ph1), the cleaning device 33 stops execution of the primary cleaning phase ph1. To this end, the electronic control unit 32 controls the cleaning pump 330 so that it stops delivering the primary cleaning fluid F1 through the ducts 333 and controls the solenoid 336 so that it closes the plurality of solenoid valves 3340. This thus implies that the electronic control unit 32 has deactivated execution of the primary cleaning phase ph1. By deactivation, what is meant is that the electronic control unit 32 has sent a command (not shown) to the cleaning device 33 to stop the primary cleaning phase ph1.

If the surface 200 is not clean (branch A2), then in an illustrated step E8, F8 (32, 21, +1), said cleaning counter 21 is incremented. It is incremented by the electronic control unit 32.

If said cleaning counter 21 is lower than a primary threshold th1, in an illustrated step E9, F9 (33, 21, th1, ph1), the cleaning device 33 reiterates the primary cleaning phase ph1. This allows the surface 200 of the sensor 20 to be cleaned again. In one non-limiting embodiment, the primary threshold th1 is equal to 3.

In one non-limiting embodiment, the primary threshold th1 is configured depending on the nature of the sensor 20. Thus, in one non-limiting example, a lidar may be more critical to operation of the autonomous or semi-autonomous motor vehicle 2 than a reversing camera. In the case of a lidar, S1=4 in one non-limiting example, and in the case of a reversing camera, S1=3 in one non-limiting example. In one non-limiting embodiment, the primary threshold th1 is configured depending on ambient parameters. In non-limiting examples, the ambient parameters are meteorological parameters such as rain or snow, or even outside temperature. Thus, in one non-limiting example, if it is snowing, or if it is raining, S1=3 in one non-limiting example, and if this is not the case, S1=2 in one non-limiting example. Thus, in one non-limiting example, if the outside temperature is lower than 0, implying that the roads will have been salted (there may be salt on the surface 200), then S1=3 in one non-limiting example, and if this is not the case, S1=2 in one non-limiting example.

Steps E4 to E8 are reiterated (branch A3) until the surface 200 is clean or until the primary threshold th1 is reached if the surface 200 is still not clean.

If the primary threshold th1 is reached, this means that the primary cleaning phase ph1 was not effective. The one or more cleaning parameters p1 and/or the primary cleaning fluid F1 must be changed. Thus, the primary phase ph1 can be executed only th1 times, i.e. three times in the non-limiting example considered of th1 equal to 3. If this limit is reached without having been able to clean the surface 200 correctly, there is no point in continuing a normal cleaning phase. To do so would ineffectively consume too much primary cleaning fluid F1.

A more effective cleaning phase is then carried out in the following manner.

If said cleaning counter 21 is equal to said primary threshold th1 (branch A4), in an illustrated step E10, F10 (33, ph1), the cleaning device 31 stops execution of the primary cleaning phase ph1. This implies that the electronic control unit 32 has deactivated execution of the primary cleaning phase ph1.

In an illustrated step E11, F11 (32, ph2, p1 (D1, P1, T1, C1)), the electronic control unit 32 activates a secondary cleaning phase ph2 with said at least one cleaning parameter p1 modified. The secondary cleaning phase ph2 is carried out with a secondary cleaning fluid F2. By activation, what is meant is that the electronic control unit 32 sends a command (not shown) to the cleaning device 33, said command comprising the cleaning parameters p1 modified so that the latter may execute the secondary cleaning phase ph2 with said cleaning parameters p1 modified.

In one non-limiting embodiment, a plurality of cleaning parameters p1 are modified.

Thus, it is possible to increase the flow rate D1 of the secondary cleaning fluid F2. This makes it easier to clean certain types of dirt, for example types of dirt that dissolve more easily in a fluid. Thus, the pressure P1 of the secondary cleaning fluid F2 may be increased. This allows more powerful and therefore faster cleaning to be achieved. Thus, the temperature T1 of the secondary cleaning fluid F2 may be increased. This makes it possible to more effectively remove mud stains for example. Thus, the composition C1 of the secondary cleaning fluid F2 may be modified. Specifically, in one non-limiting embodiment, the secondary cleaning fluid F2 is the same as the primary cleaning fluid F1, or is composed of the primary cleaning fluid F1 and of an additional fluid F3 or is different from the primary cleaning fluid F1. In one non-limiting example of embodiment, water with a solvent or water with a detergent may be used instead of water. In one non-limiting embodiment, the additional fluid F3 is a solvent. This makes it possible to more effectively remove insect remains for example. Thus, the secondary cleaning phase ph2 is a cleaning phase that is more intensive than the primary cleaning phase ph1, the latter being an ordinary cleaning phase.

In order to increase the temperature of the secondary cleaning fluid F2, in one non-limiting embodiment, the cleaning system 3 comprises resistors placed close to the storage tank 331.

In an illustrated step E12, F12 (33, ph2, F2, p1), the cleaning device 33 executes the secondary cleaning phase ph2. Thus, the cleaning pump 330 is controlled to deliver an intensive program.

In the same way as for the primary cleaning phase ph1, it is tested whether the surface 200 is clean or still dirty.

Thus, in an illustrated step E13, F13 (31, 200), the detecting device 31 checks whether the surface 200 to be cleaned is clean.

If said surface 200 to be cleaned is clean following said secondary cleaning phase ph2 (branch A5), in an illustrated step E14, F14 (32, 21, 0), said cleaning counter 21 is reset. It is reset by the electronic control unit 32.

In an illustrated step E15, F15 (33, ph2), the cleaning device 33 stops execution of the secondary cleaning phase ph2. To this end, the electronic control unit 32 controls the cleaning pump 330 so that it stops delivering the primary cleaning fluid F1 through the ducts 333 and controls the solenoid 336 so that it closes the plurality of solenoid valves 3340. This thus implies that the electronic control unit 32 has deactivated execution of the secondary cleaning phase ph2. By deactivation, what is meant is that the electronic control unit 32 has sent a command (not shown) to the cleaning device 33 to stop the secondary cleaning phase ph2.

If the surface 200 is not clean (branch A6), then in an illustrated step E16, F16 (32, 21, +1), said cleaning counter 21 is incremented. It is incremented by the electronic control unit 32.

If said cleaning counter 21 is lower than a primary threshold th1, in an illustrated step E17, F17 (33, 21, th2, ph2), the cleaning device 33 reiterates the secondary cleaning phase ph2. This makes it possible to clean the surface 200 of the sensor 20 again with the secondary cleaning fluid F2 and the one or more cleaning parameters p1 that have been modified. In one non-limiting embodiment, the secondary threshold th2 is equal to 5.

Steps E13 to E17 are reiterated (branch A7) until the surface 200 is clean or until the secondary threshold th2 is reached if the surface 200 is still not clean. Thus, the secondary phase ph2 can be executed only a number equal to th2−th1 times, i.e. two times in the non-limiting example considered of th2 equal to 5. Just as for the primary threshold th1, in one non-limiting embodiment, the secondary threshold th2 is configured depending on the nature of the sensor 20. Thus, in one non-limiting example, a lidar may be more critical to operation of the autonomous or semi-autonomous vehicle than a reversing camera. In the case of a lidar, S2=2 in one non-limiting example, and in the case of a reversing camera, S2=1 in one non-limiting example. Furthermore, just as for the primary threshold th1, in one non-limiting embodiment, the secondary threshold th2 is configured depending on ambient parameters. In non-limiting examples, the ambient parameters are meteorological parameters such as rain or snow, or even outside temperature. Thus, in one non-limiting example, if it is snowing, or if it is raining, S2=5 in one non-limiting example, and if this is not the case, S2-4 in one non-limiting example. Thus, in one non-limiting example, if the outside temperature is lower than 0, implying that the roads will have been salted, then S2=5 in one non-limiting example, and if this is not the case, S2-3 in one non-limiting example.

If the secondary threshold th2 is reached, this means that the secondary cleaning phase ph2 was also not effective and did not allow a clean surface 200 to be achieved. There is also no point in continuing this secondary cleaning phase ph2. At this moment, in an illustrated step E18, F18 (32, 21, 0), the electronic control unit 32 resets the cleaning counter 21, here to zero, and in an illustrated step E19, F19 (33, ph2), the cleaning device 33 stops execution of the secondary cleaning phase ph2. This thus implies that the electronic control unit 32 has thus deactivated execution of the secondary cleaning phase ph2.

Lastly, in an illustrated step E20, F20 (32, f1), the electronic control unit 32 executes the function f1 ensuring safety of said motor vehicle 2. This safety-ensuring function f1 of said motor vehicle 2 is an information-providing function f1 or allows the motor vehicle 2 to be used in degraded mode or prohibits use of the motor vehicle 2.

Thus, in non-limiting embodiments, the safety-ensuring function f1 is:
a message sent to a human-machine interface of said vehicle 2 to indicate the need for maintenance,
deactivation of the one or more functions of said motor vehicle 2 that depend on detection by said sensor 20,
automatic navigation of said motor vehicle 2 on a maintenance basis.

Thus, the message will make it possible to indicate that one or more sensors 20 have not been cleaned correctly, this causing a problem with their detecting function and meaning that they must be cleaned manually.

Thus, in non-limiting embodiments, one or more functions that may be deactivated without compromising the safety of the occupants of the motor vehicle 2 are driver-assistance functions such as, in non-limiting examples, an overtaking aid, a reversing aid and a parking aid, or even autonomous driving functions such as, in one non-limiting example, the autonomous parking function.

This safety-ensuring function f1 thus makes it possible to ensure the safety of the motor vehicle 2, in particular when it is autonomous or semi-autonomous. Consequently, the safety of the occupants of said motor vehicle 2 is preserved.

Thus, the cleaning method 1 is implemented by a system 3 for cleaning at least one sensor 20 of a vehicle 2, said sensor 20 comprising a surface 200 to be cleaned.

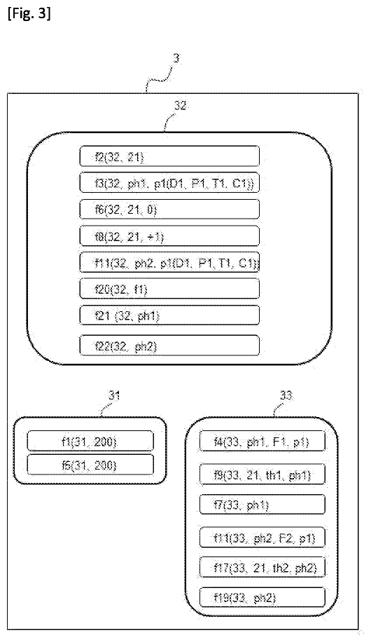

As illustrated in FIG. 3, in one non-limiting embodiment, the cleaning system 3 comprises:
the detecting device 31,
the electronic control unit 32, and
the cleaning device 33.

The detecting device 31 is configured to detect whether said surface 200 to be cleaned of said sensor 20 is dirty (function f1 (31, 200) illustrated in FIG. 3) and to check whether it is clean (function f5 (31, 200) illustrated in FIG. 3).

The electronic control unit 32 is configured to:
activate the cleaning counter 21 if the surface 200 is dirty (function f2 (32, 21) illustrated in FIG. 3),
activate a primary cleaning phase ph1 employing cleaning parameters p1 (function f3 (32, ph1, p1 (D1, P1, T1, C1) illustrated in FIG. 3),
if said surface 200 to be cleaned is clean following said primary cleaning phase ph1, reset said cleaning counter 21 (function f6 (32, 21, 0) illustrated in FIG. 3),
otherwise increment said cleaning counter 21 (function f8 (32, 21, +1) illustrated in FIG. 3),
if said cleaning counter 21 is equal to said primary threshold th1, activate a secondary cleaning phase ph2 with at least one cleaning parameter p1 modified (function f11 (32, ph2, p1 (D1, P1, T1, C1) illustrated in FIG. 3),
if said surface 200 is clean following said secondary cleaning phase ph2, reset said cleaning counter 21 (function f6), otherwise increment said cleaning counter 21 (function f8),
if said cleaning counter 21 is lower than a secondary threshold th2, activate said secondary cleaning phase ph2 (function f11), and if said cleaning counter 21 is equal to said secondary threshold th2, reset said cleaning counter 21 (function f6), and execute a function f1 ensuring safety of said vehicle 2 (function f20 (32, f1) illustrated in FIG. 3).

The electronic control unit 32 is further configured to:
deactivate said primary cleaning phase ph1 (function f21 (32, ph1) illustrated in FIG. 3) if said surface 200 is clean following said primary cleaning phase ph1 or if said cleaning counter 21 is equal to said primary threshold th1,
deactivate said secondary cleaning phase ph2 (function f22 (32, ph2) illustrated in FIG. 3) if said surface 200 is clean following said secondary cleaning phase ph2 or if said cleaning counter 21 is equal to said secondary threshold th2.

The cleaning device 33 is configured to:
execute said primary cleaning phase ph1 (function f4 (33, ph1, F1, p1) illustrated in FIG. 3),
reiterate said primary cleaning phase ph1 (function f9 (33, 21, th1, ph1) illustrated in FIG. 3),
stop execution of said primary cleaning phase ph1 (function f7 (33, ph1) illustrated in FIG. 3),
execute said secondary cleaning phase ph2 (function f11 (33, ph2, F2, p1) illustrated in FIG. 3),
reiterate said secondary cleaning phase ph2 (function f17 (33, 21, th2, ph2) illustrated in FIG. 3),
stop execution of said secondary cleaning phase ph2 (function f19 (33, ph2) illustrated in FIG. 3).

The cleaning device 33 is configured to stop execution of said primary cleaning phase ph1 if one of the following two conditions is met: if the surface 200 to be cleaned is clean following the primary cleaning phase ph1 or if said cleaning counter 21 is equal to said primary threshold th1.

The cleaning device 33 is configured to reiterate said primary cleaning phase ph1 if both of the following conditions are met: if the surface 200 to be cleaned is still not clean following the primary cleaning phase ph1 and if said cleaning counter 21 is lower than the primary threshold th1.

The cleaning device 33 is configured to stop execution of said secondary cleaning phase ph2 if one of the following two conditions is met: if the surface 200 to be cleaned is clean following the secondary cleaning phase ph2 or if said cleaning counter 21 is equal to said secondary threshold th2.

The cleaning device 33 is configured to reiterate said secondary cleaning phase ph2 if both of the following conditions are met: if the surface 200 to be cleaned is still not clean following the secondary cleaning phase ph2 and if said cleaning counter 21 is lower than the secondary threshold th2.

In non-limiting embodiments, the electronic control unit 32 is optionally embedded in a sensor 20, or is the main electronic control unit of the motor vehicle 2 that in particular deals with engine control, or is a secondary electronic control unit.

Of course, the description of the invention is not limited to the embodiments described above and to the field described above. Thus, the cleaning counter 21 may be decremented instead of incremented. Thus, on each change of cleaning phase, the cleaning counter 21 may be reset. In this case, the secondary threshold th2 is equal to 2 instead of 5 in one non-limiting embodiment.

Thus, the described invention in particular has the following advantages:
it allows a good cleaning efficiency to be obtained while guaranteeing the safety of the occupants of the vehicle 2,
by counting the number of primary cleaning phases ph1 or secondary cleaning phases ph2 and comparing them with an associated primary threshold th1 and an associated secondary threshold th2, respectively, it makes it possible to limit the consumption of cleaning fluid F (whether it be a question of the primary cleaning fluid F1 or of the secondary cleaning fluid F2) and to prevent the one or more storage tanks 331 from emptying too quickly,
by virtue of the various cleaning parameters p1, it allows more targeted and therefore more effective cleaning of the surface 200 to be cleaned,
it is an inexpensive solution that is easy to implement.

What is claimed is:

1. A method for cleaning at least one sensor of a vehicle, said at least one sensor comprising a surface to be cleaned, said cleaning method comprising steps of:
detecting whether said surface of said sensor is dirty,
triggering a cleaning counter if said surface is dirty,
activating a primary cleaning phase employing at least one cleaning parameter,
executing the primary cleaning phase,
checking whether said surface is clean,
if said surface is clean following said primary cleaning phase, resetting said cleaning counter and stopping execution of said primary cleaning phase,
otherwise incrementing said cleaning counter, and if said cleaning counter is lower than a primary threshold, reiterating said primary cleaning phase,
if said cleaning counter is equal to said primary threshold, stopping execution of said primary cleaning phase and activating a secondary cleaning phase with said at least one cleaning parameter modified,
executing said secondary cleaning phase,
checking whether said surface is clean,
if said surface is clean following said secondary cleaning phase, resetting said cleaning counter and stopping execution of said secondary cleaning phase,
otherwise incrementing said cleaning counter and if said cleaning counter is lower than a secondary threshold, reiterating said secondary cleaning phase, and if said cleaning counter is equal to said secondary threshold, resetting said cleaning counter, stopping execution of said secondary cleaning phase, and executing a function ensuring safety of said vehicle.

2. The cleaning method as claimed in claim 1, wherein said at least one cleaning parameter is:
a flow rate of a primary cleaning fluid,
a pressure of a primary cleaning fluid,
a temperature of a primary cleaning fluid,
a composition of a primary cleaning fluid.

3. The cleaning method as claimed in claim 1, wherein said primary cleaning phase is carried out with a primary cleaning fluid and said secondary cleaning phase is carried out with a secondary cleaning fluid that is the same as the primary cleaning fluid or that is composed of said primary cleaning fluid and of an additional fluid.

4. The cleaning method as claimed in claim 1, wherein said primary cleaning phase is carried out with a primary cleaning fluid and said secondary cleaning phase is carried out with a secondary cleaning fluid different from the primary cleaning fluid.

5. The cleaning method as claimed in claim 1, wherein said primary threshold is equal to 3.

6. The cleaning method as claimed in claim 1, wherein said secondary threshold is equal to 5.

7. The cleaning method as claimed in claim 1, wherein said safety-ensuring function is:
a message sent to a human-machine interface of said vehicle to indicate the need for maintenance,
deactivation of the one or more functions of said vehicle that depend on detection by said sensor,
automatic navigation of said vehicle on a maintenance basis.

8. The cleaning method as claimed in claim 1, wherein said primary threshold and said secondary threshold are configured depending on the nature of said at least one sensor.

9. The cleaning method as claimed in claim 1, wherein said primary threshold and said secondary threshold are configured depending on ambient parameters.

10. A system for cleaning at least one sensor of a vehicle, said at least one sensor comprising a surface to be cleaned, said cleaning system comprising:
(a) a detecting device configured to detect whether said surface of said at least one sensor is dirty or clean,
(b) an electronic control unit configured to:
activate a primary cleaning phase employing cleaning parameters,
if said surface is clean following said primary cleaning phase, resetting said cleaning counter, otherwise incrementing said cleaning counter,
if said cleaning counter is equal to said primary threshold, activating a secondary cleaning phase with at least one cleaning parameter modified,
if said surface is clean following said secondary cleaning phase, resetting said cleaning counter, otherwise incrementing said cleaning counter,
if said cleaning counter is equal to said secondary threshold, resetting said cleaning counter and executing a function ensuring safety of said vehicle,
(c) a cleaning device configured to:
execute said primary cleaning phase, reiterate said primary cleaning phase if said surface is still not clean following the primary cleaning phase and if said cleaning counter is lower than the primary threshold,
stop execution of said primary cleaning phase if said surface is clean following the primary cleaning phase or if said cleaning counter is equal to said primary threshold,
execute said secondary cleaning phase,
reiterate said secondary cleaning phase if said surface is still not clean following the secondary cleaning phase and if said cleaning counter is lower than the secondary threshold, and
stop execution of said secondary cleaning phase if said surface is clean following the secondary cleaning phase or if said cleaning counter is equal to said secondary threshold.
